(19) United States
(12) Patent Application Publication
(10) Pub. No.: US 2004/0110108 A1
(43) Pub. Date: Jun. 10, 2004

(54) Dental brace

(76) Inventor: Klaus Weissbach Otte, Bad Sobernheim (DE)

Correspondence Address: Davidson Berquist, Klima & Jacson LLP, Suite 920, 4501 North Fairfax Drive, Arlington, VA, 22203, US

(21) Appl. No.: 10/434,464

(22) Filed: May 9, 2003

(30) Foreign Application Priority Data
May 10, 2002 (DE) 102 21 354.2

(51) Int. Cl. A61C 3/00

(52) U.S. Cl. 433/18

(57) ABSTRACT

The invention relates to a dental brace for distalization of the molars (4, 4′) of a patient that are located on the left and right sides of the lower jaw.

To make the dental brace wearable for a relatively long period of time and to make it individually readjustable, the invention proposes a dental brace in which the bicuspids are used for bracing. To that end, the dental brace (2) includes two back and two front orthodontic collars (3, 3′, 5, 5′), which can be slipped onto the molars (4, 4′) and onto the bicuspids (6, 6′), respectively; the two front orthodontic collars (5, 5′) are joined together via an arch wire (7), which when the dental brace (2) is used as intended is located behind the incisors, and the respective adjacent back and front orthodontic collars (3, 5; 3′, 5′) on the left and right sides of the lower jaw are joined together via connection and tension elements (8, 8′, 8a).

### FIELD OF THE INVENTION

The invention relates to a dental brace for distalization of the molars of a patient located on the left and right sides of the lower jaw.

Such dental braces for distalization, that is, for pushing back one or more teeth in order to create space for proper alignment of the other teeth, are known. Typically, these dental braces are intended to move the back teeth (molars) rearward.

One known dental brace comprises a horseshoe-shaped basic body (or “Schwarz's plate”), which is adapted to the individual jaw shape. Wire clasps are anchored in the base body; two of them embrace the molars to be moved, and the others engage the teeth seated in front of them. The base body (with the wire clasps that begin there) is split, in front of the molars; the portions associated with the molars are joined to the remaining main portion via guide pins and an adjusting screw and are adjustable relative to one another. Via the adjusting screws, the pressure on the molars can be varied as needed.

This type of fastening has proved disadvantageous since the wire clasps only partly embrace the teeth. At the molars, the result is a “tilting” introduction of force that is often associated with unsatisfactory results. Moreover, because the main portion of the dental brace is also used for bracing purposes, a tilting movement of the lower-jaw incisors toward the lip (known as protrusion) occurs all too readily.

Moreover, these known dental braces make chewing more difficult, and as a rule the patient therefore has to remove them for meals and put them back in again later. They can also come loose while playing sports and can cause injuries in the region of the mouth. Finally, wearing these dental braces entails some hindrance to the patient's speech.

A brace-like device known as a lip bumper has also become known, in which a “lip shield”, extending in front of the front teeth and retained on the molars with collars, is put under pressure by the patient's lip. The pressure exerted rearward serves to correct the molars. In this known device too, often only a tilting movement occurs. Moreover, the pressure action is intrinsically quite limited. As a rule, the lip shield has to be removed for chewing and for playing sports.

Fixed dental braces (known as “distal jets”) developed especially for the upper jaw are also known, in which a plastic plate is provided for placement against the palate region. The plastic plate acts as both a bracing element and a connecting element, to which the segments of the wire that begin at the collars are connected. Since in the lower jaw the bottom of the mouth is movable and thus cannot be used to near a load, and since the tongue attachment also divides this region, such a device is not usable in the lower jaw.

Finally, corrective devices of other types for the area of the lower jaw are also known, namely the kind that can be inserted into the oral vestibule (cheek region). However, as a rule, they bring about only a unilateral correction of the teeth.

### SUMMARY OF THE INVENTION

The object of the invention is to propose a dental brace which can be worn for a relatively long period of time and can be readjusted individually and which in the final analysis is more efficient than comparable known dental braces.

This object is attained according to the invention by the characteristics of claim 1. Further advantageous features of the invention are disclosed by the dependent claims.

The invention is based on the concept that the patient should be given as little occasion as possible to take the dental brace out and thus continually change its seating. The invention therefore proposes a fixed dental brace in which the deciduous molars or bicuspids located in front of the molars are used for bracing.

The bicuspids or deciduous molars are surrounded not by wire clasps but by orthodontic collars (that is, relatively wide metal rings) and are joined to one another via an arch wire (lingual arch) that extends behind the incisors. This arch wire is also used for bracing. The molars are likewise embraced by orthodontic collars. Wire segments oriented toward one another begin both at the collars of the molars and at the collars of the bicuspids or deciduous molars, or the connecting arch common to them, and these wire segments are connectable via connection and tension elements and are individually activatable. In particular, the connection and tension elements are so-called screw brackets.

Prestressable springs can also be interposed. These springs can each be surrounded by and guided in a sheath. A lip shield can also be joined to the orthodontic collars of the molars, in order to press the molars rearward. The lip shield can furthermore be joined to the bicuspids or deciduous molars in front of the molars to be moved, for the sake of better bracing. The force of the spring is then optimally transmitted.

The dental brace of the invention has the advantage, among others, that it can be worn continuously. The action time is thus longer, and the progress of a selected adjustment lasts longer. The treatment can be accomplished quickly and in a controlled way.

With the dental brace of the invention, instead of a tilting movement, a sliding movement of the molars takes place; this effect can be still further reinforced by providing that the engagement point of the arch wire and the orthodontic collars of the bicuspids is located approximately in the middle portion of the collars, and that the connection and tension elements extend between the adjacent front and back orthodontic collars, below the edge of the gum. The point of force engagement is thus located in the upper third of the entire tooth, including its root, which is equivalent to the geometric center of growth.

### BRIEF DESCRIPTION OF THE DRAWINGS

Further details and advantages of the invention will become apparent from the following exemplary embodiments explained in conjunction with drawings. Shown are:

FIG. 1, schematically, a plan view on the teeth of a lower jaw with the dental brace of the invention inserted, in a lower jaw in which the second dentition is complete;

FIG. 2, an enlarged view of FIG. 1 in the area marked II, in section;

FIG. 2a, a view corresponding to FIG. 2 for a somewhat different embodiment.

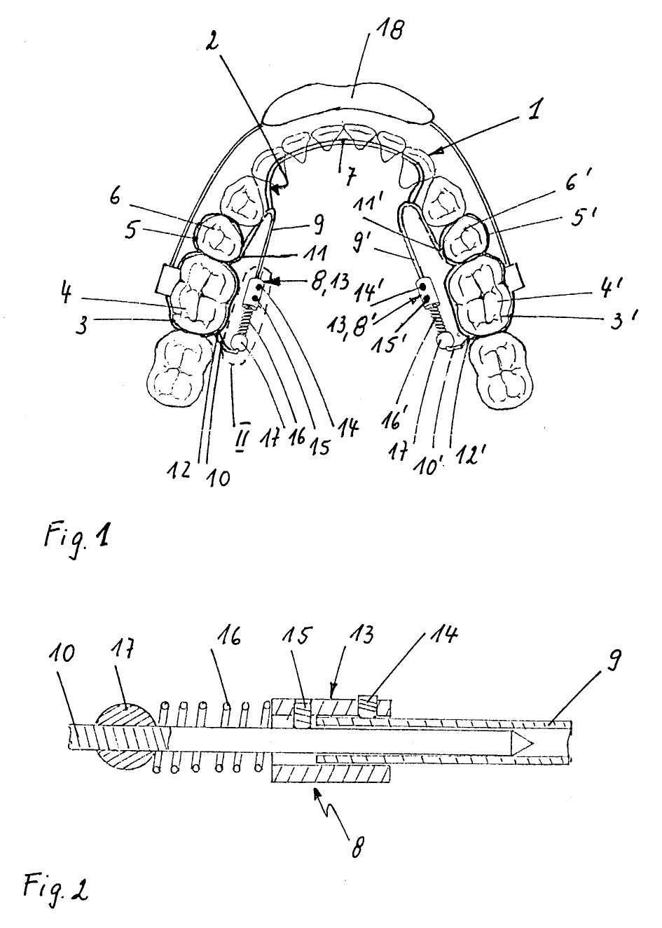

In FIG. 1, 1 indicates the dentition of a lower jaw, and 2 indicates a dental brace of the invention. The dental brace includes two back orthodontic collars 3, 3′, which are each slipped onto the first molars 4, 4′ of the dentition 1, and two front orthodontic collars 5, 5′, which are each slipped onto the second bicuspids 6, 6′, or second deciduous molars, of the dentition 1. The two front orthodontic collars 3, 3′ are joined together via an arch wire 7 disposed behind the incisors.

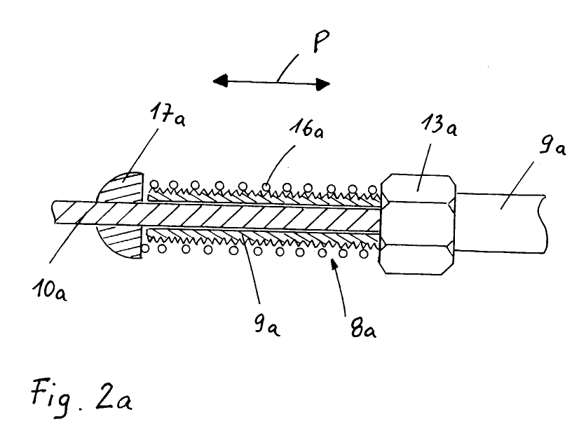

The respective adjacent back and front orthodontic collars 3 and 5, and 3′ and 5′, respectively, are joined together on each side of the lower jaw via respective connection and tension elements 8, 8′. These connection and tension elements 8, 8′ are spring-loaded telescoping rod assemblies, each with two rods 9, 10 and 9′, 10′ (FIG. 2), respectively, that can be displaced one inside the other. The first of the two rods 9, 9′ is embodied as a tube, and the second rod 10, 10′ can be inserted at least partway into it. The ends facing away from one another, 11, 12 and 11′, 12′ (FIG. 1), respectively, of the two rods 9, 10 and 9′, 10′ are each joined by nonpositive engagement (for instance being soldered) to one of the adjacent orthodontic collars 3 and 5, and 3′ and 5′, respectively.

The respective connection and tension element 8, 8′ furthermore includes a tubular fastening element 13, 13′, which has a diameter that is greater than the diameter of the tubular first rod 9, 9′. The respective fastening element 13, 13′ has two screws 14, 15 and 14′, 15′, respectively, disposed axially in succession, which can be screwed into the wall of the fastening element 13, 13′ from the outside inward, and with which the two rods 9, 10 and 9′, 10′ can be joined in their final positions to the tubular fastening element 13, 13′ and thus can be fixed relative to one another.

The respective connection and tension element 8, 8′ finally includes a cylindrical spring 16, 16′, which is braced on one side on the edge of the tubular fastening element 13, 13′ and on the other on a bead 17, 17′ of the second rod 10, 10′. By means of this cylindrical spring 16, 16′, it is attained that when the second screw 15, 15′ that fixes the second rod 10, 10′ is loosened, a pressure is constantly exerted on the first molars.

The dental brace 2 can therefore initially be worn by the patient without fixation of the second rod 10, 10′ on the fastening element 13, 13′, and then only after a predetermined length of time, once the first molars 4, 4′ have shifted rearward by a predetermined distance, be fixed in that position. An unwanted return of these teeth to their previous position can thus be prevented.

As can be seen from FIG. 1, the dental brace 2 has a lip shield 18, known per se, which is joined to the orthodontic collars 3, 3′ of the molars 4, 4′ so as to act additionally on them.

The embodiment shown in FIG. 2a of a connection and tension element 8a likewise includes a telescoping rod assembly, and once again a first (outer) rod 9a acts as a guide for a second (inner) rod 10a. The two rods 9a, 10a are braced with their ends (not shown) facing away from one another on different molars and bicuspids. The first rod 9a, on its (front) end oriented toward the second rod 10a, is provided with a male thread, on which a screw nut 13a can be adjusted in the direction of the front end of the rod 9a and back again from there—as indicated by the double arrow P. The second rod 10a has a stationary bead 17a, here in the form of a half-ball, at some distance from its front end.

A cylindrical spring 16a is also movably disposed above the front end of the first rod 9a, and the screw nut 13a on one side and the bead 17a on the other form a stop for this spring. By the approach of the screw nut 13a toward the bead 17a, the spring 16a comes under increasing pressure, as a result of which, finally, stronger and stronger adjusting forces in the direction of the desired correction of the malocclusion become effective at the molars and bicuspids.

This embodiment of a connection and tension element is distinguished by especially simple, secure manipulation upon adjustment and readjustment. Instead of simple screw nuts, screw nuts embodied to be self-locking can be used, for effectively preventing unwanted yielding of the screw nut (out of its selected position). Finally, especially small structural units are also possible with this embodiment.

List of Reference Numerals

| | |
|---|---|
| 1 | Dentition |
| 2 | Dental brace |
| 3, 3′ | Collars |
| 4, 4′ | Molars or back teeth |
| 5, 5′ | Collars |
| 6, 6′ | Premolars or bicuspids |
| 7 | Arch wire |
| 8, 8′, 8a | Connection and tension elements |
| 9, 9′, 9a | First rod |
| 10, 10′, 10a | Second rod |
| 11, 11′ | Ends |
| 12, 12′ | Ends |
| 13, 13′ | Fastening elements |
| 13a | Screw nut |
| 14, 14′ | First screws |
| 15, 15′ | Second screws |
| 16, 16′, 16a | Cylindrical spring |
| 17, 17′, 17a | Bead |
| 18 | Lip shield |
| P | Double arrow |

1. A dental brace for distalization of the molars (4, 4′) of a patient, located on the left and right sides of the lower jaw, having the following characteristics:
a) the dental brace (2) includes two back and two front orthodontic collars (3, 3′, 5, 5′) that can be slipped onto the molars (4, 4′) and the bicuspids (6, 6′), respectively;
b) the two front orthodontic collars (5, 5′) are joined together via an arch wire (7) that in the intended use of the dental brace (2) is disposed behind the incisors,
c) the back and front orthodontic collars (3, 5; 3′, 5′), adjacent one another on the left and right sides of the lower jaw, respectively, via connection and tension elements (8, 8′, 8a).

2. The dental brace of claim 1, characterized in that the back and front orthodontic collars (3, 5; 3′, 5′) of the respective side of the lower jaw are disposed such that they can be slipped onto immediately adjacent molars and bicuspids (4, 6; 4′, 6′).

3. The dental brace of claim 1 or 2, characterized in that the connection and tension element (8, 8′, 8a) includes a telescoping rod assembly with two rods (9, 10; 9′, 10′; 9a, 10a) that are displaceable inside one another, and the ends (11, 12; 11′, 12′) remote from one another of the two rods (9, 10; 9′, 10′; 9a, 10a) are each connected by nonpositive engagement to one of the adjacent orthodontic collars (3, 5; 3′, 5′).

4. The dental brace of claim 3, characterized in that the connection and tension element (8, 8′, 8a) is a spring-loaded telescoping rod assembly.

5. The dental brace of one of claims 1-4, characterized in that the connection and tension element (8, 8′) furthermore includes a tubular fastening element (13, 13′), through which the two rods (9, 10; 9′, 10′) can be passed, and that in the tubular wall of the fastening element (13, 13′), at least two screws (14, 15; 14′, 15′) that can be screwed radially from the outside inward are provided axially in succession, with which screws the two rods (9, 10; 9′, 10′) can be fixed in a predetermined final position.

6. The dental brace of one of claims 1-4, characterized in that the connection and tension element (8a) is a so-called screw bracket, which is embodied such that the first rod (9a), on its front end oriented toward the second rod (10a), is provided with a male thread on which a screw nut (13a) is adjustable toward the front end of the rod (9a) and back from it again, and that a cylindrical spring (16a, for which the screw nut (13a) on one side and a bead (17a) on the second rod (10a) on the other form a stop, is disposed movably above the front end of the first rod (9a).

7. The dental brace of one of claims 1-6, characterized in that a lip shield (18) is additionally connected to the two back orthodontic collars (3, 3′).

8. The dental brace of one of claims 1-7, characterized in that the respective point of engagement of the arch wire (7) with the front orthodontic collars (5, 5′) is located approximately in the middle portion of these collars (5, 5′).

9. The dental brace of one of claims 1-8, characterized in that the connection and tension elements (8, 8′, 8a) between the adjacent back and front orthodontic collars (3, 5; 3′, 5′) are located below these collars, and preferably below the edge of the gum.
